(19) United States
(12) Patent Application Publication
(10) Pub. No.: US 2015/0317127 A1
(43) Pub. Date: Nov. 5, 2015

(54) SYSTEM FOR METAMODELING UNIFICATION

(71) Applicant: MYONGJI UNIVERSITY INDUSTRY AND ACADEMIA COORPERATION FOUNDATION, Yongin-si Gyeonggi-do (KR)

(72) Inventors: Hyuk Soo JANG, Gyeonggi-do (KR); Hyo Sik YANG, Seoul (KR); Seok Yeol YUN, Seoul (KR); Dae Kyoo KIM, Gyeonggi-do (KR); Herbert FALK, Sterling Heights, MI (US); Dae-Seung HONG, Gyeonggi-do (KR); Sangsig KIM, Rochester Hills, MI (US); Byunghun LEE, Rochester Hills, MI (US)

(73) Assignee: MYONGJI UNIVERSITY INDUSTRY AND ACADEMIA COORPERATION FOUNDATION, Gyeonggi-do (KR)

(21) Appl. No.: 14/404,373

(22) PCT Filed: Feb. 24, 2014
(86) PCT No.: PCT/KR2014/001484

§ 371 Date: Nov. 26, 2014

(30) Foreign Application Priority Data
Sep. 10, 2013 (KR) 10-2013-0108724

(51) Int. Cl. G06F 9/44

(52) U.S. Cl. CPC G06F 8/10

(57) ABSTRACT

The present invention relates to a metamodeling unification system, in particular to a system for metamodeling unification to guarantee interoperability between an UML model of IEC 61850 and an UML model of IEC 61970.

According to the invention, all IEC 61970 smart grid application using IEC 61850 data source easily obtains interoperability between applications and actively react to change of international standard because application developers use data by referring to a single UML IEC 61850/61970 unified model and refer to a single UML model reflecting flexibly constant modification of IEC standard, if any.

### TECHNICAL FIELD

The present invention relates to a system for metamodeling unification, more particularly to providing a system unifying two standards in UML metamodel level in order to guarantee smooth data exchange and interoperability between an application based on IEC 61970 and a system based on IEC 61850 in a smart grid.

### BACKGROUND ART

Prior art including Korean publication No. 2007-0038993, “Data converting method”, and etc. are disclosed and registered.

Reviewing its configuration, the prior art relates to a method for transforming IEC 61850 data for substation automation, which comprises a first step of data transformer connecting to IEC 61850 server, reading IED information, and understanding IED hierarchical structure and IED list registered in IEC 61850 server; a second step of grouping list required for system control based on the apprehended information from the first step; a third step of generating tag needed for system control based on IED, Group, Item information; and a fourth step of storing generated tag in DB and informing that to the higher system by download. Thus, it relates to a method for transforming IEC 61850 data for substation automation to enable data acquired from IEC61850 server to be used for SCADA system, in which IEC 61850 is positioning as an international standard.

Current substations, power plants, distribution systems, distributed power systems, etc. are operated based on IEC 61850, and IEC 61970 applications including SCADA, EMS, Asset management, etc. are operated based on CIM (Common Information Model). Interoperability between two standards should be guaranteed so that CIM-based applications and substation system using respectively IEC 61850 and IEC 61970 can exchange information needed to each other. Currently it depends on simple 1:1 mapping between data in order to realize interoperability.

This method of exchanging data between IEC 61850 and IEC 61970 using 1:1 data mapping requires a lot of time and efforts as the number of data points for mapping is increased. Also, interoperability cannot be guaranteed for the change of a modeling method and the contents for mapping implementation need to be changed for addition and deletion of data according to expansion and modification of the standard.

Accordingly a mistake of a mapper (application developer) who implements data mapping can cause a fatal problem to the result of application. Also, there are problems that application lacks expandability, linkage between applications is difficult and time for developing takes long.

### DISCLOSURE

### Technical Problem

The present invention is for providing a system for UML-based metamodeling unification unifying two standards, i.e. IEC 61850 and ICE 61970 in metamodel unit in order to guarantee smooth data exchange and interoperability in the smart grid by solving those problems above.

### Technical Solution

The present invention comprises an input unit for receiving data from outside and editing them, an object definition unit for receiving input data through the input unit and defining IEC 61850 and IEC 61970; an infrastructure configuration unit for configuring IEC 61850 and IEC 61970 objects defined by the object definition unit according to object level; an identification unit for identifying a data-flow scenario of the said IEC 61850 and IEC 61970 and identifying an object from in each scenario; a comparison & analysis unit for comparing syntactic information of the identified object; and a unification unit for unifying syntactically equivalent objects. Preferably, the object definition unit comprises a receiving module for receiving IEC 61850 and IEC 61970 input data received through the input unit; an IEC 61850 object configuration module for configuring object of the IEC 61850 input data; and an IEC 61970 object configuration module for configuring object of the IEC 61970 input data.

Also, preferably the infrastructure configuration unit comprises, M0 level module for transforming an object of IEC 61850 and IEC 61970 configured as input through the object definition unit to an object model in configuration; M1 level module for transforming an object model of IEC 61850 and IEC 61970 of M0 level module by semantic abstraction; and M2 level module for transforming a metamodel designating abstract syntax of M1 level module in configuration.

Also preferably the infrastructure configuration unit further comprises an expansion module for expanding a metamodel of IEC 61850 by configuring an object and structure of a substation while setting a semantic element describing logical node class and input data in a metaclass.

And more preferably, the metaclass configures for connection of structure of substation and IED (Intelligent Electronic Device).

And preferably, the unification unit unifies IEC 61850 and IEC 61970 objects which have the same meaning according to the analysis result of meaning of identified IEC 61850 and IEC 61970 objects in the comparison & analysis unit.

### Advantageous Effects

According to the present invention, all IEC 61970 smart grid application developers using IEC 61850 data source can easily obtain interoperability between applications by using data referring to invented single UML IEC 61850/61970 unified model unlike previous method of implementing 1:1 data mapping for data exchange between two standards. Also the single UML model reflecting dynamically continuous modification of IEC standard is referred thus change of the international standard is actively reacted.

Accordingly, the present invention presents the advantage that IEC 61850 (field devices, current transformers, transformers, renewable energy, energy storages, condition monitoring, etc.) and IEC 61970 applications (smart grid application such as EMS, SCADA, Asset, Planning, condition monitoring, etc.) obtain interoperability by referring to GWIB (Grid Wise Information Base) defined based on a unified model of two standards. And it is applicable to most smart gird applications advantageously.

And it is easily applicable to any new data standard, thus interoperability can be obtained and automated data exchange based on UML is enabled advantageously.

### DESCRIPTION OF DRAWINGS

FIG. 1 is a block diagram showing a system for metamodeling unification according to an exemplary embodiment of the present invention.

FIG. 2 is a diagram showing an infrastructure of a system for metamodeling unification according to an exemplary embodiment of the present invention.

FIG. 3 is an exemplary diagram illustrating a power substation of a system for metamodeling unification according to an exemplary embodiment of the present invention.

FIG. 4 is a diagram illustrating an infrastructure of IEC 61850 of a system for metamodeling unification according to an exemplary embodiment of the present invention.

FIG. 5 is a diagram illustrating an infrastructure of IEC 61970 of a system for metamodeling unification according to an exemplary embodiment of the present invention.

FIG. 6 is a diagram illustrating a unified model of a system for metamodeling unification according to an exemplary embodiment of the present invention.

FIG. 7 is a diagram illustrating over-current and over-voltage protection of a system for metamodeling unification according to an exemplary embodiment of the present invention.

FIG. 8 is a diagram illustrating matching quality of a system for metamodeling unification according to an exemplary embodiment of the present invention.

FIG. 9 is a diagram illustrating matching time stamp of a system for metamodeling unification according to an exemplary embodiment of the present invention.

FIG. 10 is a diagram illustrating an infrastructure of a unified model of a system for metamodeling unification according to an exemplary embodiment of the present invention.

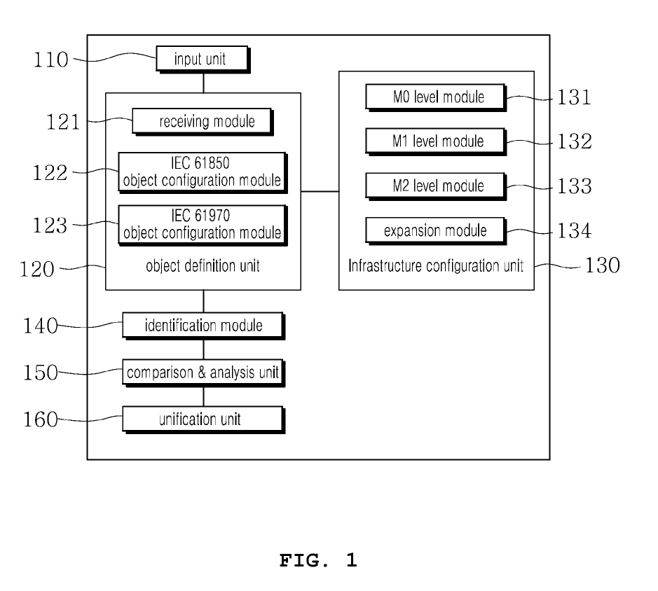

### DESCRIPTION OF THE REFERENCE NUMERALS IN THE DRAWINGS

110: input unit
120: object definition unit
121: receiving module
122: IEC 61850 object configuration module
123: IEC 61970 object configuration module
130: Infrastructure configuration unit
131: M0 level module
132: M1 level module
133: M2 level module
134: expansion module
140: identification module
150: comparison & analysis unit
160: unification unit

### BEST MODE

The present invention is for providing a UML metamodel-based system for unifying IEC 61860 standard and IEC 61970 standard in order to guarantee interoperability in a smart grid.

The present invention for metamodel unification comprises an input unit 110, an object definition unit 120, and an infrastructure configuration unit 130, an identification unit 140, a comparison & analysis unit 150, and a unification unit 160.

The input unit 110 is configured to receive data from outside and edit them.

The object definition unit 120 is configured to receive data received via the input unit 110 and define IEC 61850 and IEC 61970.

The object definition unit 120 comprises a receiving module 121 for receiving IEC 61850 and IEC 61970 input data received through the input unit, an IEC 61850 object configuration module 122 for configuring object of the IEC 61850 input data, and an IEC 61970 object configuration module 123 for configuring object of the IEC 61970 input data according to received data.

The infrastructure configuration unit 130 is for setting IEC 61850 and IEC 61970 objects received through the object definition unit 120 by level. This infrastructure configuration unit 130 comprises M0 level module 131, M1 level module 132, M2 level module 133.

M0 level module 131 is configured for transforming IEC 61850 and IEC 61970 objects set as input through the object definition unit to object model.

M1 level module 132 is configured for semantic abstraction of object model of IEC 61850 and IEC 61970 and transforming that to class model.

And M2 level module is configured for transforming a metaclass model for designating abstract syntax of class model of M1 level module.

The infrastructure setting unit 130 further can comprise the expansion module 134 for expanding a metamodel of IEC 61850 by setting object and structure of substation while setting semantic element describing logical node and input data in the metaclass model.

Herein, metaclass is for setting connection structure between substation structure and IED (Intelligent Electronic Device).

The identification unit is configured to analyze a data flow scenario of IEC 61850 and IEC 61970 and identify objects according to each scenario. Herein, data flow in two directions, bottom-up in which data are transmitted from IEC 61850 to IEC 62970, and top-down in which data are transmitted from IEC 61970 to IEC 61850. Bottom-up means a case that data collected in sub-systems such as a substation are transmitted to host systems such as SCADA for supervision and management of the overall grid. Because the scale is larger than top-down that control information flows down from a host system for controlling a sub-system, a unified model performs based on bottom-up data flow.

The comparison & analysis unit 150 compares precise semantic information of identified objects of IEC 61850 and IEC 61970 in a specific scenario.

The unification unit 160 is configured to unify semantically equivalent objects. The unification unit unifies objects of IEC 61850 and IEC 61970 which are the same in meaning according to the result analyzed by the comparison & analysis unit. In case there is an object in IEC 61970 which doesn't have an object of the same meaning in IEC 61850, a corresponding object can be added in IEC 61970.

It is necessary to guarantee interoperability between sub-system (substation, power station, distribution system and distributed power system) established based on IEC 61850 and host system (SCADA, EMS, Asset management) established based on CIM (Common Information Model) including IEC 61850, allowing them to work together in the smart grid.

The present invention provides a system for meta modeling transformation which builds the foundation to guarantee interoperability between two standards (IEC 61850, IEC 61970) by establishing GWIB (Grid Wise Information Base) covering overall application based on a unified model in order to satisfy those requirements above.

Metamodeling IEC 61850 and IEC 61970

IEC 61850 for operating sub-system such as substation, and IEC 61970 for operating host system are related to different range of system. However, they have a concept in common inside a large boundary of the smart grid. Thus identification and review for the common concepts have to be considered by priority in order to unify these two standards.

Two standards IEC 61850 and IEC 61970 can be defined in perspective of model described in UML (Unified Modeling Language). Thus it is possible to define a single unified model unifying models of two standards.

Various tools are needed for model transformation, mapping generation, suitability evaluation to develop a unified model of two standards.

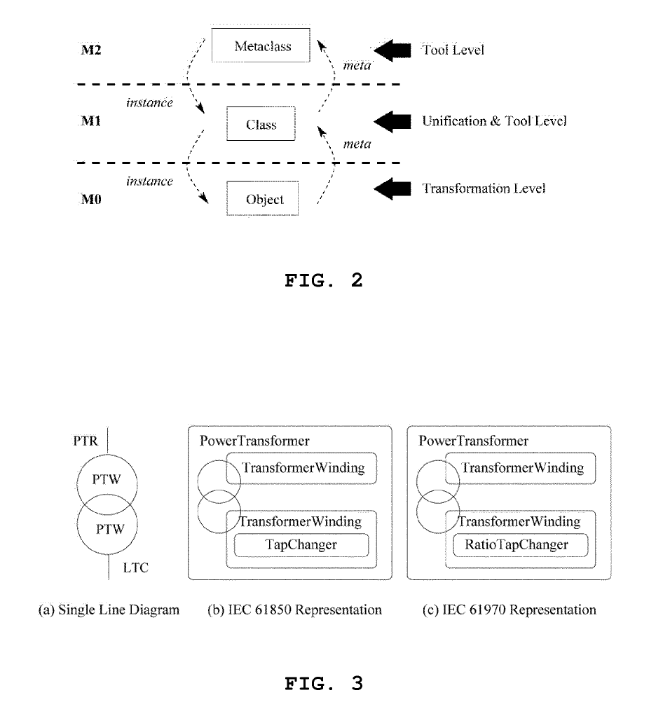

FIG. 2 is a diagram illustrating an infrastructure of UML unified model system according to an exemplary embodiment of the present invention.

As illustrated in FIG. 2, a meta modeling approach is presented to define a unified model of IEC 61850 and IEC 61970 using a three-layer infra. Herein, the infra comprises three levels such as metamodel level (M2), model level (M1), and object level (M0).

Metamodel level (M2) defines a metaclass model, model level (M1) includes a class model i.e. an instance of the metaclass model as an element. Model level (M1) defines a class model, object level (M0) includes an object model, i.e. an instance of the class model. On the contrary, a metamodel of an object model is a class model; a metamodel of class model is a metaclass model.

In FIG. 2, top-down shows an instance relation, bottom-up shows a meta relation.

From standard content of the current version, IEC 61850 and IEC 61970 models are designable only in model level (M1) not in metamodel level (M2). Thus the unification of two standards under development is operated in model level (M1).

Also, the two standards can be defined by UML, but it should be considered that IEC 61850 is incomplete relatively than IEC 61970.

IEC 61850 defines models respectively in 4 levels, metameta level, meta level, domain type level, and data instance level.

Metameta level is required to define basic type, general data characteristic, nesting, composition. However, the elements of metameta level in IEC 61850 are defined as meta model in the present invention because the detailed information of required elements are not explained.

Other three levels correspond to three-layer layers of FIG. 2. Merely the metamodel of IEC 61850 guarantees only part 7 of IEC 61850, but expands by including also defining content of part 6 of IEC 61850 in order to compose the metamodel shown in FIG. 2.

For reference, part 6 and part 7 of IEC 61850 is disclosed in Communication Networks and System in Substation Automation, Std., 2001-2005.

IEC 61970 defines model in two types of levels, domain type level and data instance level, and these two types of levels correspond to respectively M1 level and M0 level of FIG. 2.

As explained above, IEC 61850 performs defining model with 4 levels, and IEC 61970 performs defining model with 2 levels. Accordingly the infra difference of the two standards made it difficult and complicating to unify the standards. However, the three-layer layer infrastructure shown in FIG. 2 enables to set the same level of abstract concept in performing unifying the standards, and provides accuracy.

A metamodeling method developed defines a unified model which unifies metamodels of the two standards in M2 meta level among three-layer layers in FIG. 2. IEC 61850 system developer and IEC 61970 application developer obtain interoperability between the two standards by using the unified model developed through metamodeling.

IEC 61850 system and IEC 61970 application which are already operated based on respective standard are supported by using model-base technology such as QVT (Query View Transformation) which supports automated transformation between the two standards through the unified model.

Taking a power transformer in FIG. 3 as an example in order to describe three-layer infrastructure of IEC 61850 and IEC 61970, FIG. 3(a) is a single line diagram illustrating a transformer comprising two transformer windings and a tap changer. FIGS. 3(b) and (c) illustrates the content of a transformer with the same composition defined respectively by IEC 61850 and IEC61970.

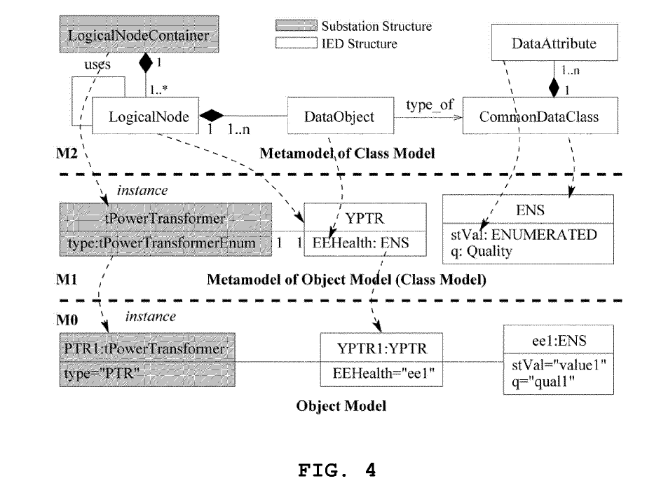

FIG. 4 illustrates partial 3-layer infra of IEC 61850 for FIG. 3(b). LogicalNodeContainer, LogicalNote, DataObject, CommonDataClass and DataAttribute metaclasses are defined in M2 level. LogicalNodeContainer metaclass represents substation objects of IEC 61850 part 6 representing configuration of substation, and other metaclasses represent semantic elements describing logical node class and data of IEC 61850 part 7.

This metamodel expands metamodel of meta of IEC 61850 by including IEC 61850 part 6, and helps to identify classes related to part 6 and part 7 of IEC 61850.

LogicalNodeContainer class of M2 level in 3-layer infra is moved to tPowerSystemResource class which is defined as its instance in M1 level.

LogicalNode metaclass represents logical nodes like YPTR, and their attribute is data object defined as instance of DataObject metaclass. Herein, data object has CDC (Common Data Class) expressed by CommonDataClass metaclass as data type.

Composition relation between LogicalNodeContainer metaclass and LogicalNode metaclass connects substation structure defined in IEC 61850 part 6 and IED (Intelligent Electronic Device) structure defined in IEC 61850 part 7.

Looking into relation between classes according to 3-layer infra precisely by taking an example of data value, YPTR class in FIG. 4 is instance of LogicalNode metaclass EEHealth attribute of YPTR class is instance of DataObject metaclass, ENS type of EEHealth attribute is instance of CommonDataClass metaclass.

M0 level defines objects as instance of M1 level classes. Object has a specific value of runtime data as well as a static value for system configuration. For example, object YPTR1: YPTR class has “EE1” as value of EEHealth attribute. The said value “EE1” is instance of ENS common data class, and has “value1” and “qual1” as stVal and q attribute value.

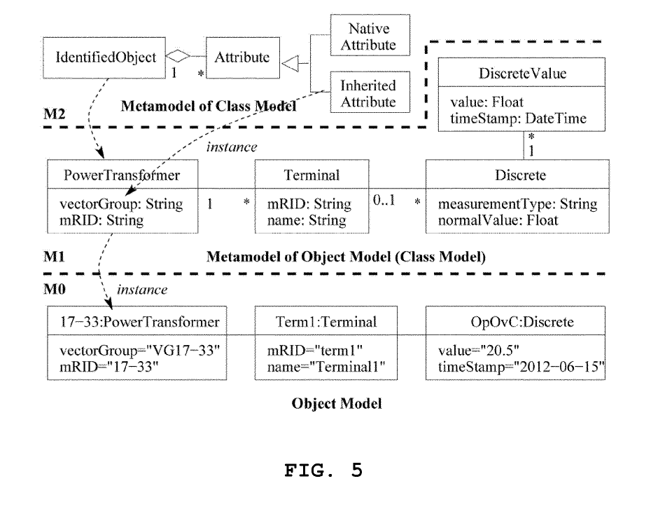

FIG. 5 shows 3-layer infra of IEC 61970 for FIG. 3(c). The meta model of M2 level defines IdentifiedObject metaclass capturing all domain object of IEC 61970. IdentifiedObject metaclass comprises attributes defined by Attribute metaclass, and Attribute metaclass is defined by inheritance relation having NativeAttribute and InheritedAttribute metaclasses as sub-class.

IdentifiedObject metaclass has PowerTransformer class and Terminal class defined in Wire package of IEC 61970 as instance. Measurement classes such as DiscreteValue class and Discrete class defined in Measurement package are related to designation of measured value through Terminal class. However IEC 61970 is described better in UML than IEC 61850, there is no definition about the meta model. It can be seen as the reason that conventionally IEC 61970 model is designed by using UML modeling tool such as EA (Enterprise Architect) in IEC 61970.

Unifying IEC 61850 and IEC 61970

In a smart grid, data flows in two directions, bottom-up from IEC 61850 to IEC 61970, and top-down from IEC 61970 to IEC 61850.

Bottom-up information exchange means that data collected in a sub-system such as a substation is transmitted to a host system such as SCADA for supervision and management of the overall grid. Because the scale is larger than top-down that control information flows down from a host system for controlling a sub-system, a unified model performs based on bottom-up data flow.

Unifying IEC 61850 and IEC 61970 is operated as follows based on infrastructure in FIGS. 4 and 5.

Scenario of bottom-up and top-down data flow is identified (S1).

Next, entities related to IEC 61850 and IEC 61970 are identified in each scenario (S2).

Next, meaning of identified entities is compared (S3).

Next, elements which are equivalent in meaning are unified (S4). Herein, one-to-one correspondence is not necessary and one-to-majority or majority-to-one correspondence is possible.

Next, the entities which don't have their corresponding elements in IEC 61970 are added to the unified model (S5). Herein, appropriate relation must be established between newly added entities and entities of IEC 61970. In case the added entity is a class, attributes of the added class need to be checked if there is overlap with IEC 61970.

Last, data form related to the identified entity is unified (S6).

It should be noted that however a transformation system under development is to develop a new model by unifying IEC 61850 and IEC 61970 models in metamodel level; this is integration in which IEC 61850 is absorbed with IEC 61970 as the center. Thus, in case the respectively investigated data in two standards have a same meaning to confirm the overlap, data of IEC 61850 are removed and data of IEC 61970 are shared. And data of IEC 61850 which don't have data with the same meaning in IEC 61970 are added to compose a unified model. However, data which are used for operation of CIM-based application must be included by a unified model.

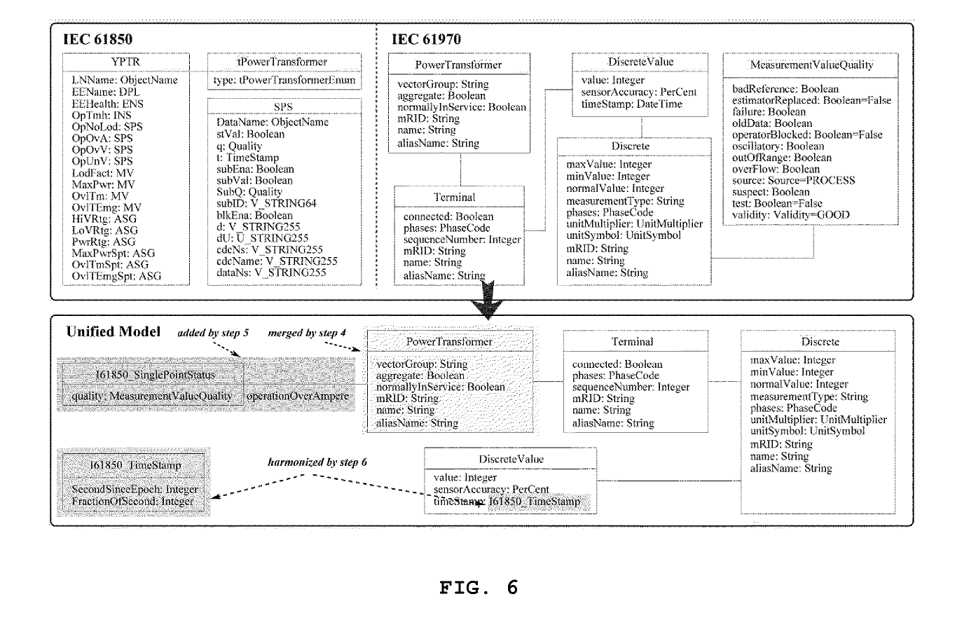

FIG. 6 shows unified model of IEC 61850 and IEC 61970 designed by unifying process of 6 steps (S1˜S6) above for an example of power transformer in FIG. 3. For convenience, power transformer is assumed to be checked between S1 and S3 for simplification.

A power transformer of IEC 61850 is defined by YPTR logical node of part 7 and tPowerTransformer class of part 6. tPowerTransformer class is just information of phase, actual data are sent to CIM level through SCD (System Configuration Data) file of IEC 61850.

YPTR logical node contains information about configuration and condition of a power transformer as well as measurement and measured values in power transformer, and they are defined respectively by specific CDC. For example, measured value is provided by MV (Measurement) CDC, condition information is described by SPS (Single Point Status) CDC.

A power transformer of IEC 61970 is expressed by PowerTransformer class in Wire package, and the data are described in Discrete, Discrete Value and MeasurementValueQuality class in Measurement package. For convenience, other type of information (for example, load element, equipment conditions) is not considered in the present exemplary embodiment

When the identified class is given, unification is performed as follows.

tPowerTransformer class of IEC 61850 and PowerTransformer class of IEC 61970 are unified by step S4 of unifying objects which are equivalent in meaning because they represent the same concept (U1). Herein, a unified class is named PowerTransformer.

CDCs (for example, ENS, INS, SPS) representing information of YPTR class in IEC 61850 are added to the unified model by S5 step of adding entities in IEC 61850 of which mapping is impossible because there is not an entity of same meaning in IEC 61970 to the unified model (U2). Herein, it should be noted that values of CDCs and logical node of IEC 61850 added to the unified model are not operated in CIM application program, thus they are not matter of interest From the same perspective, the unified model of the exemplary embodiment also defines data which are operated only in CIM to application program.

Because this unifying method can minimize the change over expansion and modification of the standard that can occur thereafter, operation of the unified model is facilitated and gradual development is possible.

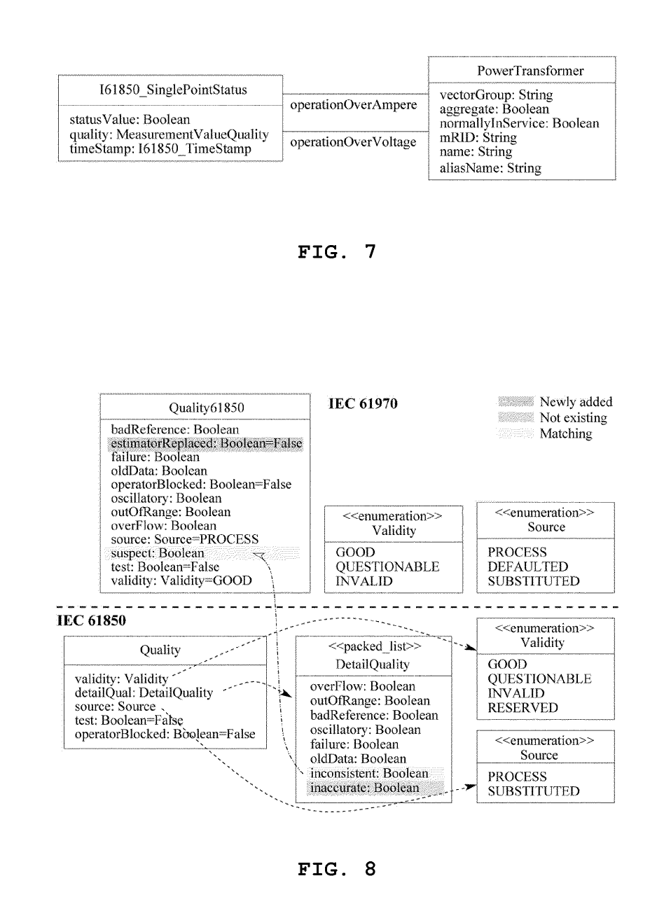

stVal, q and t attributes inside SPS CDC defining opOvA attribute in YPTR have mandatorily their value described, and also they are object of unification as attributes of interest needed for operation of CIM application program. opOvA attribute is added into a unified model as relevant relation under the name of operationOverAmpere between PowerTransformer class and I61850 SinglePointStatus class representing SPS CDC of IEC 61850. In case over-voltage protection data (opOvV) as well as over-current (opOvA) is needed to be transmitted, the relevant relation is added as illustrated in FIG. 7.

stVal and t attributes in SPS CDC of IEC 61850 are basically identical to each other as data having value and timeStamp attributes in DiscreteValue class respectively of IEC 61970. Thus stVal and t attributes of SPS are removed as overlapped data, and another essential element q (Quality) only remains in I61850 SinglePointStatus class.

When a unified model is generated in U2 by using CDCs of IEC 61850, unification between attribute types can be considered in S6 step (U3). For example, in case a unified model is defined for three kinds of attributes stVal, t, q of SPS CDC in IEC 61850, there exists Boolean type, for Boolean type of stVal attribute, which is explicitly identical in IEC 61970, unification is possible by using it.

However, there is no data type in IEC 61970 which is the same as TimeStamp type oft attribute and q attribute of Quality type for SPS CDC in IEC 61850.

FIG. 8 shows the result of matching Quality 61850 class and Quality data type of IEC 61850. Because Quality61850 type is defined based on IEC 61850 Quality type as seen from the name, they are semantically same as illustrated in FIG. 8.

However, Quality61850 is a type unifying two types by including DetailQuality type attribute as well as Quality type attribute. However, inaccurate attribute of DetailQuality type is not matched with Quality61850 attribute, estimatorReplaced attribute of Quality61850 represents the attribute which doesn't have a matched attribute in Quality or DetailQuality type and is newly added to IEC 61970.

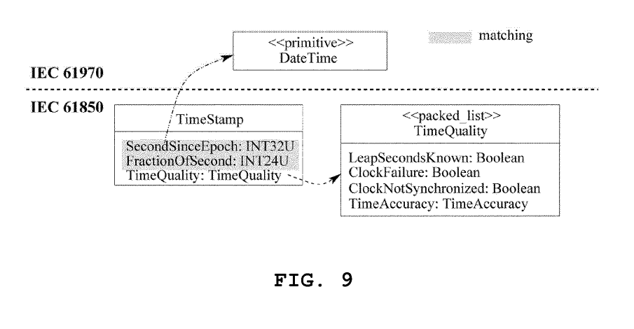

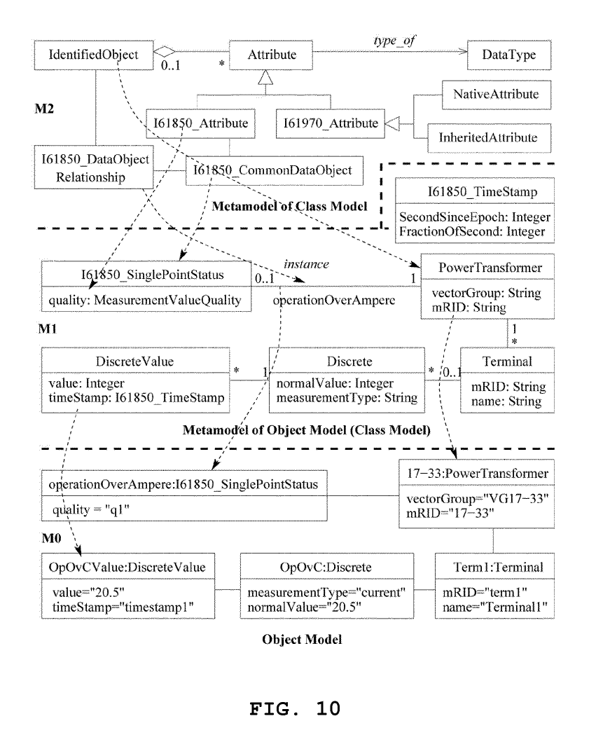

As illustrated in FIG. 9, TimeStamp of IEC 61850 and DateTime of IEC 61970 are semantically identical to each other, but cannot be directly mapped to each other. Thus, I61850_TimeStamp is added to unified model in order to keep using TempStamp of IEC 61850 instead of DateTime of IEC 61970 as shown in FIG. 6. Herein, SecondSinceEpoch attribute of TimeStamp type represents time measured by second based on UTC (Universal Time Coordinated) 00:00:00 Jan. 1, 1970, and FractionOfSecond attribute represents time accuracy of second.

According to a meta modeling transformation system according to an exemplary embodiment of the present invention, all IEC 61970 smart grid application using IEC 61850 data source easily obtains interoperability between applications and actively react to change of international standard because application developers use data by referring to a single UML IEC 61850/61970 unified model and refer to a single UML model reflecting flexibly constant modification of IEC standard, if any.

Accordingly, IEC 61850 data source (field equipments, current transformers, transformers, renewable energy, storage, condition monitoring, etc.) and all IEC 61970 application (EMS, SCADA, Asset, Planning, condition monitoring, etc. smart grid applications) refer to GWIB, thus they will be applied to almost all smart grid applications.

And it can be easily applied to any new data standard, thus interoperability can be obtained and automated data exchange is possible based on UML advantageously.

What is claimed is:

1. A system for metamodeling unification, the system comprising:
an input unit for receiving data from outside and editing them;
an object definition unit for receiving input data through the input unit and defining IEC 61850 and IEC 61970;
an infrastructure configuration unit for configuring IEC 61850 and IEC 61970 objects defined by the object definition unit according to level;
an identification unit for identifying a data-flow scenario of the said IEC 61850 and IEC 61970 and identifying an object in each scenario;
a comparison & analysis unit for comparing syntactic information of the identified object; and
a unification unit for unifying syntactically equivalent objects, wherein the infrastructure configuration unit comprises M0 level module for transforming an object of IEC 61850 and IEC 61970 configured as input through the object definition unit into an object model in configuration, M1 level module for transforming the object model of IEC 61850 and IEC 61970 of M0 level module by semantic abstraction in configuration, and M2 level module for transforming a metamodel designating abstract syntax of M1 level module in configuration.

2. The system for metamodeling unification of claim 1, wherein the object definition unit comprises a receiving module for receiving IEC 61850 and IEC 61970 input data through the input unit;
an IEC 61850 object configuration module for configuring an object of the said IEC 61850 input data; and
an IEC 61970 object configuration module for configuring an object of the said IEC 61970 input data.

3. The system for metamodeling unification of claim 1, wherein the infrastructure configuration unit further comprises an expansion module for expanding a metamodel of IEC 61850 by configuring an object and structure of a substation while setting a semantic element describing logical node class and input data in a metaclass.

4. The system for metamodeling unification of claim 3, wherein the metaclass configures for connection of structure of substation and IED (Intelligent Electronic Device).

5. The system for metamodeling unification of claim 1, wherein the unification unit unifies IEC 61850 and IEC 61970 objects which have the same meaning according to the analysis result of meaning of identified IEC 61850 and IEC 61970 objects in the comparison & analysis unit.
